(19) United States
(12) Patent Application Publication
(10) Pub. No.: US 2020/0164643 A1
(43) Pub. Date: May 28, 2020

(54) LIQUID DISCHARGE HEAD AND FLOW PATH MEMBER

(71) Applicant: TOSHIBA TEC KABUSHIKI KAISHA, Tokyo (JP)

(72) Inventors: Masayuki Satomi, Sunto Shizuoka (JP); Ryutaro Kusunoki, Mishima Shizuoka (JP)

(21) Appl. No.: 16/550,462

(22) Filed: Aug. 26, 2019

(30) Foreign Application Priority Data
Nov. 22, 2018 (JP) 2018-219709
Mar. 6, 2019 (JP) 2019-040873

(51) Int. Cl. B41J 2/14

(52) U.S. Cl. CPC B41J 2/1433; B41J 2002/14419

(57) ABSTRACT

According to one embodiment, a liquid discharge head includes a plate and a flow path base. The plate includes a pressure chamber which is opened to one main surface, a liquid introduction portion which converts a flow direction of a liquid to a flow toward the pressure chamber on a secondary side of the flow direction of the liquid at an opening of the pressure chamber, and a nozzle which is connected to the pressure chamber, is opened to the other main surface, and discharges the liquid. The flow path base is provided on one main surface side of the plate and forms a liquid chamber in which the liquid flows with the plate along a surface direction of the one main surface.

### CROSS-REFERENCE TO RELATED APPLICATIONS

This application is based upon and claims the benefit of priority from Japanese Patent Application No. 2018-219709, filed on Nov. 22, 2018 and 2019-040873, filed on Mar. 6, 2019 the entire contents of both of which are incorporated herein by reference.

### FIELD

Embodiments described herein relate generally to a liquid discharge head, a flow path member, and an inkjet printer.

### BACKGROUND

In the related art, a flow path member having a chamber in a direction orthogonal to a flow path of a liquid flowing in one direction has a problem that it is difficult for the liquid to circulate in the chamber. For example, as the flow path member, a liquid discharge head which discharges a liquid such as ink used in a printing apparatus or the like can be mentioned. The liquid discharge head has a function of discharging a liquid in a pressure chamber from a nozzle by deformation of the pressure chamber which discharges the liquid. However, when it is difficult for the liquid to circulate in the pressure chamber, the liquid in the nozzle is dried and thickened during printing standby.

### DESCRIPTION OF THE DRAWINGS

FIG. 1 is a schematic view of a liquid discharge apparatus according to a first embodiment;

FIG. 2 is an exploded perspective view showing a configuration of a liquid discharge head of the liquid discharge apparatus;

FIG. 3 is a cross-sectional view of the liquid discharge head;

FIG. 4 is a plan view showing a configuration of a main part of a liquid introduction portion of the liquid discharge head;

FIG. 5 is a cross-sectional view showing the configuration of the main part of the liquid introduction portion;

FIG. 6 is a cross-sectional view of a liquid discharge head according to a second embodiment;

FIG. 7 is a plan view showing a configuration of a main part of a liquid introduction portion of the liquid discharge head;

FIG. 8 is a cross-sectional view showing the configuration of the main part of the liquid introduction portion;

FIG. 9 is a cross-sectional view showing a configuration of a main part of a flow path member according to a third embodiment;

FIG. 10 is a flowchart showing an example of a method of manufacturing a liquid discharge head according to a fourth embodiment;

FIG. 11 is an explanatory view showing the example of the method of manufacturing the liquid discharge head;

FIG. 12 is a cross-sectional view schematically showing a configuration and a method of manufacturing a liquid discharge head according to a fifth embodiment; and

FIG. 13 is a plan view showing a configuration of members used in the liquid discharge head.

### DETAILED DESCRIPTION

Embodiments provide a liquid discharge head and a flow path member capable of circulating a liquid in a chamber with a simple configuration.

In general, according to one embodiment, a liquid discharge head includes a plate and a flow path base. The plate includes a pressure chamber which is opened to one main surface, a liquid introduction portion which converts a flow direction of a liquid to a flow toward the pressure chamber on a secondary side of the flow direction of the liquid at an opening of the pressure chamber, and a nozzle which is connected to the pressure chamber, is opened to the other main surface, and discharges the liquid. The flow path base is provided on one main surface side of the plate and forms a liquid chamber in which the liquid flows with the plate along a surface direction of the one main surface.

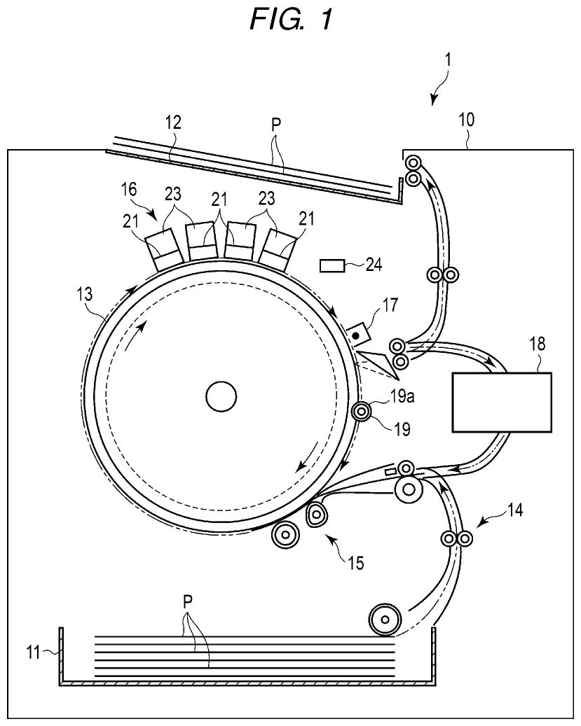

Hereinafter, a liquid discharge apparatus 1 having a liquid discharge head according to a first embodiment will be described with reference to FIGS. 1 to 5.

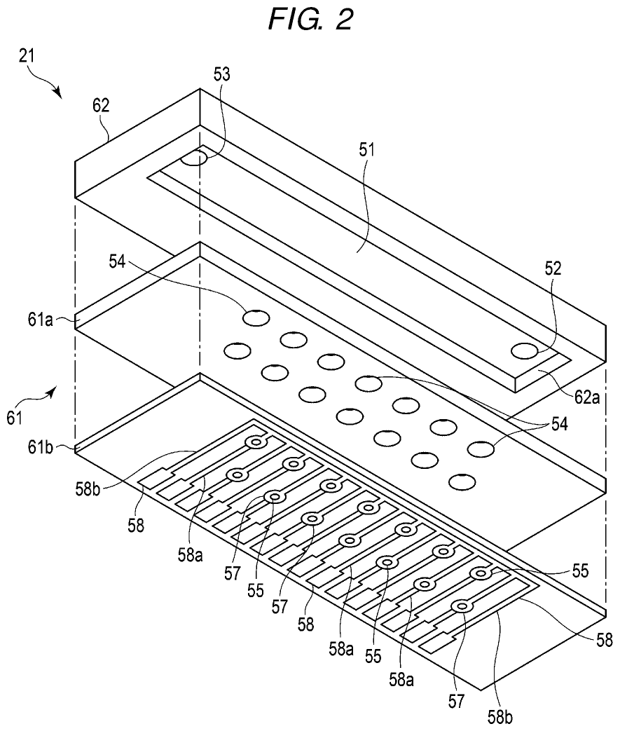

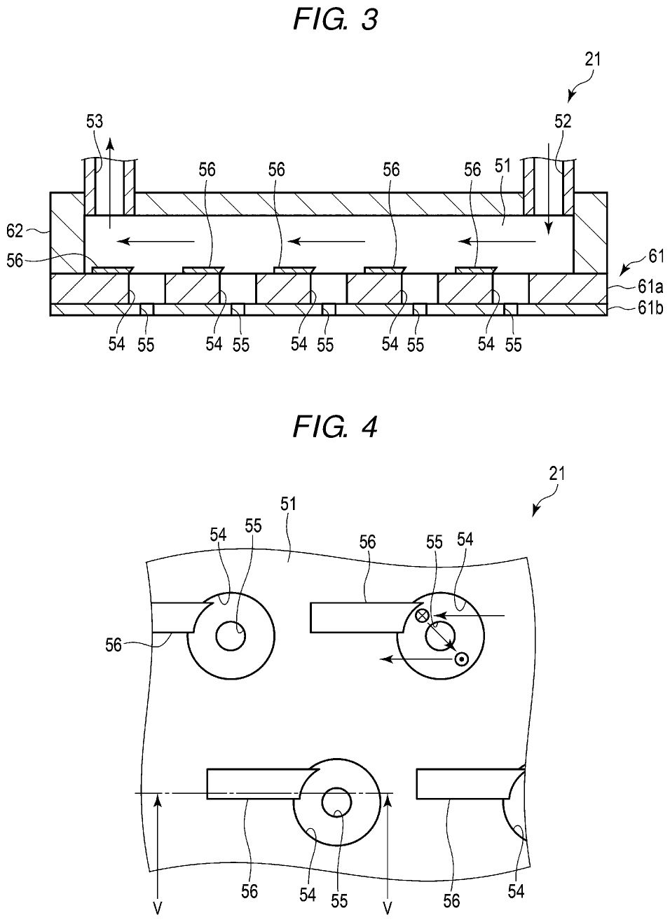

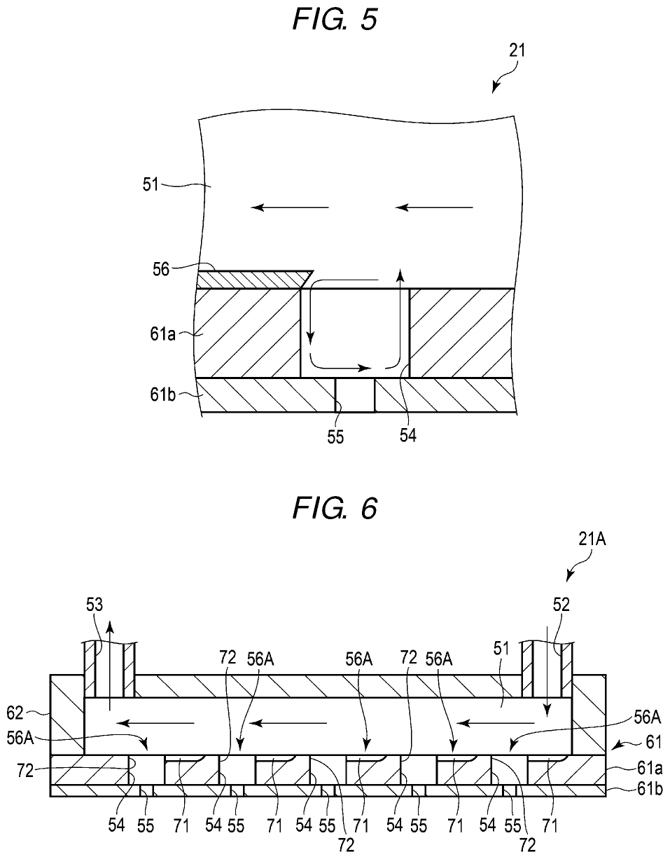

FIG. 1 is a schematic view of the liquid discharge apparatus 1 according to the first embodiment, FIG. 2 is an exploded perspective view showing the configuration of a liquid discharge head 21 of the liquid discharge apparatus 1, FIG. 3 is a cross-sectional view of the liquid discharge head 21, FIG. 4 is a plan view showing the configuration of the main part of a liquid introduction portion 56 of the liquid discharge head 21, and FIG. 5 is a cross-sectional view showing the configuration of the main part of the liquid introduction portion 56 taken along line V-V. In the liquid discharge head 21 shown in FIGS. 3 to 5, electrodes 58 and drive elements 57 are omitted.

As shown in FIG. 1, the liquid discharge apparatus 1 is a recording apparatus such as an inkjet printer. As shown in FIG. 1, the liquid discharge apparatus 1 performs various processes such as image formation while conveying a recording paper P, which is a recording medium, for example. The liquid discharge apparatus 1 includes a housing 10, a paper feeding cassette 11, a paper discharge tray 12, a holding roller 13, a conveying device 14, a holding device 15, an image forming device 16, a static elimination peeling device 17, a reversing device 18, and a cleaning device 19.

The paper feeding cassette 11 accommodates a plurality of recording papers P. The paper feeding cassette 11 is disposed in the housing 10. The paper discharge tray 12 is disposed in the upper part of the housing 10. The paper discharge tray 12 receives the discharged recording paper P on which an image is formed.

The conveying device 14 has a plurality of guides and a plurality of conveyance rollers disposed along a path along which the recording paper P is conveyed. The conveyance roller is driven by a motor to rotate and thus conveys the recording paper P from the paper feeding cassette 11 to the paper discharge tray 12.

The holding roller 13 has a cylindrical frame formed of a conductor and a thin insulating layer formed on the surface of the frame. The frame is connected to ground. The holding roller 13 conveys the recording paper P by rotating while holding the recording paper P on the surface thereof.

The holding device 15 causes the recording paper P carried out from the paper feeding cassette 11 by the conveying device 14 to adhere to the outer peripheral surface of the holding roller 13 and causes the holding roller 13 to hold the recording paper. After pressing the recording paper P against the holding roller 13, the holding device 15 causes the recording paper P to adhere to the holding roller 13 by electrostatic force due to charging.

The image forming device 16 forms an image on the recording paper P held on the outer surface of the holding roller 13 by the holding device 15. The image forming device 16 includes a plurality of liquid discharge heads 21 facing the surface of the holding roller 13, a plurality of ink tanks 23 connected to the plurality of liquid discharge heads 21, and a plurality of control units 24 connected to the plurality of liquid discharge heads 21. The plurality of liquid discharge heads 21 form an image by discharging, for example, cyan, magenta, yellow, and black inks of four colors onto the recording paper P, respectively.

The liquid discharge head 21 is connected to the ink tank 23 containing ink of the corresponding color. The liquid discharge head 21 discharges ink droplets onto the recording paper P held by the holding roller 13 to form characters and an image.

As shown in FIG. 1, the ink tank 23 stores a liquid such as ink. The plurality of ink tanks 23 are respectively connected to the liquid discharge heads 21.

As shown in FIG. 1, the control unit 24 transmits a signal for driving the drive elements 57 to a plurality of wiring electrodes 58a described later.

As shown in FIG. 1, the static elimination peeling device 17 peels off the recording paper P from the holding roller 13 by eliminating electricity from the recording paper P on which the image is formed. As a specific example, the static elimination peeling device 17 supplies electric charge to eliminate electricity from the recording paper P, inserts a pawl between the recording paper P and the holding roller 13, and peels off the recording paper P from the holding roller 13. The recording paper P peeled off from the holding roller 13 is conveyed to the paper discharge tray 12 or the reversing device 18 by the conveying device 14.

As shown in FIG. 1, the reversing device 18 reverses the front and back surfaces of the recording paper P peeled off from the holding roller 13 and supplies the recording paper P again to the front surface of the holding roller 13. The reversing device 18 reverses the recording paper P by, for example, conveying the recording paper P along a predetermined reversing path for inversely switching back the recording paper P in the front-rear direction.

As shown in FIG. 1, the cleaning device 19 cleans the holding roller 13. The cleaning device 19 is located on the downstream side of the static elimination peeling device 17 in the rotational direction of the holding roller 13. The cleaning device 19 brings a cleaning member 19a into contact with the surface of the rotating holding roller 13, and cleans the surface of the rotating holding roller 13.

As shown in FIGS. 2 and 3, the liquid discharge head 21 includes, for example, a common liquid chamber (first chamber) 51, a suction port 52, a discharge port 53, a plurality of pressure chambers (second chambers) 54, a plurality of nozzles 55, a plurality of liquid introduction portions 56, the drive elements 57, and the electrodes 58. Further, as shown in FIG. 2, the liquid discharge head 21 includes a plate 61 and a flow path base 62. In the liquid discharge head 21, the common liquid chamber 51, the suction port 52, the discharge port 53, the plurality of pressure chambers 54, the plurality of nozzles 55, and the plurality of liquid introduction portions 56 are formed by integrally assembling the plate 61 and the flow path base 62.

As shown in FIGS. 2 and 3, the common liquid chamber 51 is a flow path extending in one direction. The common liquid chamber 51 is, for example, a rectangular plate-shaped space which is long in one direction and is formed between one main surface of the plate 61 and a main surface of the flow path base 62 opposite to the plate 61.

As shown in FIGS. 2 and 3, the suction port 52 is provided on a primary side of the common liquid chamber 51. The suction port 52 is connected to the ink tank 23 via a pipe or the like. The discharge port 53 is provided on a secondary side of the common liquid chamber 51. The discharge port 53 is connected to the ink tank 23 via a pipe or the like.

As shown in FIGS. 2 and 3, the pressure chamber 54 is a chamber that is recessed in a direction orthogonal to the flow direction of the liquid flowing in the common liquid chamber 51. For example, the pressure chamber 54 is opened to the one main surface of the plate 61 and is connected to the common liquid chamber 51. The pressure chamber 54 is, for example, a cylindrical chamber provided in the plate 61 and has a circular opening. The pressure chamber 54 is a closed chamber in a direction orthogonal to the flow direction of the liquid flowing in the common liquid chamber 51, and is capable of discharging the liquid from the nozzle 55 by driving the driving element 57.

As shown in FIGS. 2 and 3, each nozzle 55 is connected to each pressure chamber 54 and is opened to the other main surface of the plate 61. The nozzle 55 is, for example, a cylindrical or truncated cone-shaped space provided on the plate 61.

As shown in FIGS. 3 to 5, the liquid introduction portion 56 converts the flow direction of the liquid flowing in the common liquid chamber 51 into the flow toward the pressure chamber 54 on the secondary side of the pressure chamber 54 in the flow direction of the liquid flowing in the common liquid chamber 51. As a specific example, the liquid introduction portion 56 is a protrusion provided on the one main surface of the plate 61. The end face of the liquid introduction portion 56 on the pressure chamber 54 side is inclined with respect to the flow direction of the liquid flowing in the common liquid chamber 51 and faces the pressure chamber 54. In other words, the end face of the liquid introduction portion 56 on the pressure chamber 54 side is inclined to the one main surface of the plate 61 so as to face the pressure chamber 54.

As shown in FIGS. 4 and 5, for example, the width of the liquid introduction portion 56 in the direction orthogonal to the flow direction of the liquid flowing in the common liquid chamber 51 is smaller than the width of the pressure chamber 54 in the direction orthogonal to the flow direction of the liquid flowing in the common liquid chamber 51, that is, the inner diameter of the pressure chamber 54.

Further, for example, the width of the liquid introduction portion 56 in the direction orthogonal to the flow direction of the liquid flowing in the common liquid chamber 51 is smaller than half of the width of the pressure chamber 54 in the direction orthogonal to the flow direction of the liquid flowing in the common liquid chamber 51. That is, the width of the liquid introduction portion 56 in the direction orthogonal to the flow direction of the liquid flowing in the common liquid chamber 51 is smaller than the radius of the pressure chamber 54. The liquid introduction portion 56 is disposed to be shifted in a direction orthogonal to the flow direction of the liquid flowing in the common liquid chamber 51 from the center of the pressure chamber 54 in the flow direction of the liquid flowing in the common liquid chamber 51 and the end in the direction orthogonal to the flow direction of the liquid flowing in the common liquid chamber 51.

As shown in FIG. 2, the drive elements 57 are respectively disposed around the plurality of nozzles 55. For example, the drive elements 57 are provided on the other main surface of the plate 61 and around the nozzles 55. The drive elements 57 are disposed coaxially with the nozzles 55 and have an annular shape.

As shown in FIG. 2, the electrodes 58 are respectively connected to the plurality of drive elements 57. The electrode 58 includes, for example, a wiring electrode 58a and a common electrode 58b. The wiring electrode 58a is used as an individual electrode for independently driving the drive element 57.

As shown in FIG. 2, the plate 61 is formed in a rectangular plate shape. The plate 61 includes, for example, the plurality of pressure chambers 54, the plurality of nozzles 55, the plurality of liquid introduction portions 56, the driving elements 57 provided in the nozzles 55, and the electrodes 58 connected to the driving elements 57. The plate 61 includes, for example, a first plate 61a in which the plurality of pressure chambers 54 are formed, and a second plate 61b in which the plurality of nozzles 55, the driving elements 57, and the electrodes 58 are formed and are formed by integrally laminating these components.

As shown in FIG. 2, the flow path base 62 has a rectangular plate shape. The flow path base 62 includes a rectangular plate-like recess 62a long in one direction, the suction port 52 connected to the recess 62a on one end side of the recess 62a in the longitudinal direction, and the discharge port 53 connected to the recess 62a on the other end side of the recess 62a in the longitudinal direction. The plate 61 and the flow path base 62 are a flow path portion that forms the common liquid chamber 51 by being integrally combined.

According to the liquid discharge head 21 of the liquid discharge apparatus 1 configured as described above, when some of the liquid flowing in the common liquid chamber 51 hits the end face of the liquid introduction portion 56, the flow of some of the liquid is converted into a flow toward the pressure chamber 54 by the end face of the liquid introduction portion 56. Therefore, the liquid discharge head 21 can guide some of the liquid flowing in the common liquid chamber 51 to the pressure chamber 54 by the liquid introduction portion 56. Since the liquid can be introduced into the pressure chamber 54, the generation of the flow of the liquid in the pressure chamber 54 prevents the liquid from staying in the pressure chamber 54 and increasing the viscosity of the liquid.

In addition, by making the width of the liquid introduction portion 56 in the direction orthogonal to the flow direction of the liquid flowing in the common liquid chamber 51 smaller than the width of the pressure chamber 54, the flow returning to the common liquid chamber 51 from the pressure chamber 54 can be generated. As a result, since the flow in which the liquid is introduced into the pressure chamber 54 and the flow in which the liquid is discharged from the pressure chamber 54 are generated, the liquid discharge head 21 can guide the liquid to the pressure chamber 54 more easily.

As described above, since the liquid in the pressure chamber 54 circulates even during printing standby, the liquid discharge apparatus 1 can prevent the liquid in the nozzles from being dried and thickened during printing standby.

The liquid introduction portion 56 is a protrusion having an inclined surface which is provided on the secondary side of the pressure chamber 54 in the flow direction in which the liquid in the common liquid chamber 51 flows. Therefore, the liquid discharge head 21 can introduce the liquid into the pressure chamber 54 only by providing the liquid introduction portion 56 having a simple configuration.

As described above, according to the liquid discharge apparatus 1 according to the first embodiment, the liquid introduction portion 56 which converts the flow direction of the some of the liquid flowing in the common liquid chamber into a flow toward the pressure chamber 54 is provided on the secondary side of the pressure chamber 54 of the liquid discharge head 21. Therefore, the liquid discharge head 21 can introduce the liquid into the pressure chamber 54 with a simple configuration.

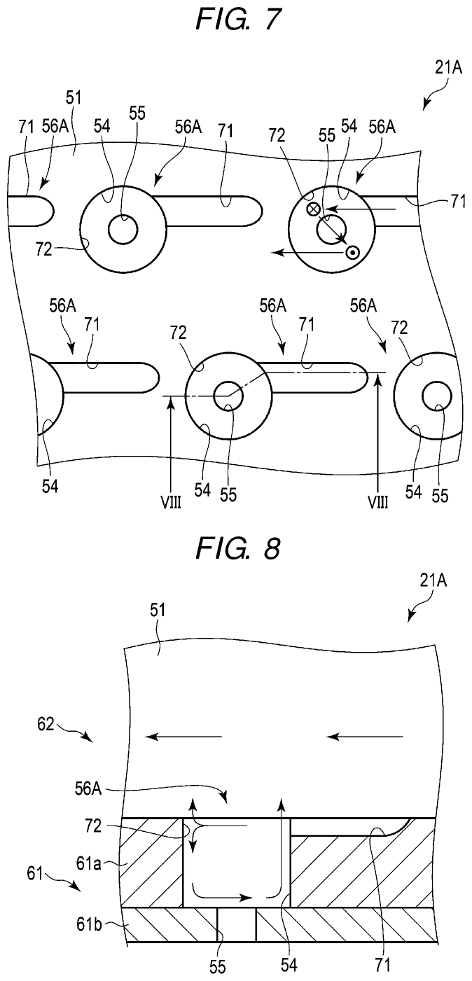

Next, a liquid discharge head 21A used in a liquid discharge apparatus 1 according to a second embodiment will be described using FIGS. 6 to 8. FIG. 6 is a cross-sectional view of the liquid discharge head 21A according to the second embodiment. FIG. 7 is a plan view showing the configuration of the main part of a liquid introduction portion 56A of the liquid discharge head 21A. FIG. 8 is a cross-sectional view showing the configuration of the main part of the liquid introduction portion 56A taken along line VIII-VIII in FIG. 7. In the liquid discharge head 21A shown in FIGS. 6 to 8, the electrodes 58 and the drive elements 57 are omitted. In the configuration of the liquid discharge head 21A according to the second embodiment, the same components as those of the liquid discharge head 21 according to the first embodiment described above are denoted by the same reference numerals, and the detailed description thereof will be omitted.

As shown in FIG. 6, the liquid discharge head 21A is connected to the ink tank 23 containing ink of the corresponding color. The liquid discharge head 21A discharges ink droplets onto a recording paper P held by the holding roller 13 to form characters and an image.

The liquid discharge head 21A includes, for example, the common liquid chamber 51, the suction port 52, the discharge port 53, the plurality of pressure chambers 54, the plurality of nozzles 55, a plurality of liquid introduction portions 56A, the drive elements 57, and the electrodes 58. Further, as shown in FIGS. 6 and 8, the liquid discharge head 21A includes the plate 61 and the flow path base 62. In the liquid discharge head 21A, the common liquid chamber 51, the suction port 52, the discharge port 53, the plurality of pressure chambers 54, the plurality of nozzles 55, and the plurality of liquid introduction portions 56A are formed by integrally assembling the plate 61 and the flow path base 62.

As shown in FIGS. 6 to 8, the liquid introduction portion 56A converts the flow direction of the liquid flowing in the common liquid chamber 51 into a flow toward the pressure chamber 54 on the secondary side of the pressure chamber 54 in the flow direction of the liquid flowing in the common liquid chamber 51. As a specific example, the liquid introduction portion 56A includes a first liquid introduction portion 71 configured by a groove provided on one main surface of the plate 61, and a second liquid introduction portion 72 that is a part of a wall portion of the pressure chamber 54.

As shown in FIGS. 7 and 8, the first liquid introduction portion 71 is a groove provided on the primary side of the pressure chamber 54 in the flow direction of the liquid flowing in the common liquid chamber 51 on the one main surface of the plate 61. The first liquid introduction portion 71 is provided along the flow direction of the liquid flowing in the common liquid chamber 51. For example, the first liquid introduction portion 71 is long in the direction along the flow direction of the liquid flowing in the common liquid chamber 51. In the first liquid introduction portion 71, the depth of the primary side becomes gradually deeper from the primary side to the secondary side, and the middle part of the primary side to the secondary side has a certain depth. For example, the width of the first liquid introduction portion 71 in the direction orthogonal to the flow direction of the liquid flowing in the common liquid chamber 51 is smaller than the width of the pressure chamber 54 in the direction orthogonal to the flow direction of the liquid flowing in the common liquid chamber 51, that is, the inner diameter of the pressure chamber 54.

Further, the width of the first liquid introduction portion 71 in the direction orthogonal to the flow direction of the liquid flowing in the common liquid chamber 51 is smaller than half of the width of the pressure chamber 54 in the direction orthogonal to the flow direction of the liquid flowing in the common liquid chamber 51. That is, the width of the first liquid introduction portion 71 in the direction orthogonal to the flow direction of the liquid flowing in the common liquid chamber 51 is smaller than the radius of the pressure chamber 54. The first liquid introduction portion 71 is disposed to be shifted in a direction orthogonal to the flow direction of the liquid flowing in the common liquid chamber 51 from the center of the pressure chamber 54 in the flow direction of the liquid flowing in the common liquid chamber 51 and the end in the direction orthogonal to the flow direction of the liquid flowing in the common liquid chamber 51.

As shown in FIG. 8, the second liquid introduction portion 72 is a portion of the wall portion of the pressure chamber 54 on the secondary side in the flow direction of the liquid flowing in the common liquid chamber 51. Specifically, the second liquid introduction portion 72 is a portion of the wall portion of the pressure chamber 54 facing the first liquid introduction portion 71 in the flow direction of the liquid flowing in the first liquid introduction portion 71.

According to the liquid discharge head 21A configured as described above, some of the liquid flowing in the common liquid chamber 51 flows through the first liquid introduction portion 71 and hits the second liquid introduction portion 72, and then some of the liquid is converted into the flows toward the inside of the pressure chamber 54 and the outside of the pressure chamber 54 by the second liquid introduction portion 72. The liquid is introduced into the pressure chamber 54 by the flow toward the inside of the pressure chamber 54.

Thus, the liquid discharge head 21A can guide some of the liquid flowing in the common liquid chamber 51 to the pressure chamber 54 by the liquid introduction portion 56A. Since the liquid can be introduced into the pressure chamber 54, the flow of the liquid in the pressure chamber 54 is generated and thus it is possible to prevent the liquid from staying in the pressure chamber 54 and increasing the viscosity of the liquid.

In addition, by making the width of the liquid introduction portion 56A in the direction orthogonal to the flow direction of the liquid flowing in the common liquid chamber 51 smaller than the width of the pressure chamber 54, the flow returning to the common liquid chamber 51 from the pressure chamber 54 can be generated. Thus, the flow in which the liquid is introduced into the pressure chamber 54 and the flow in which the liquid is discharged from the pressure chamber 54 are generated so that the liquid discharge head 21A can more easily guide the liquid to the pressure chamber 54.

Further, the liquid can be introduced into the pressure chamber 54 by the liquid introduction portion 56A with a simple configuration in which the first liquid introduction portion 71 that is a groove along the flow direction of the liquid in the common liquid chamber 51 in the one main surface of the plate 61, and the second liquid introduction portion 72 is formed as a part of the wall portion of the pressure chamber 54.

As described above, according to the liquid discharge head 21A in the liquid discharge apparatus 1 according to the second embodiment, the liquid introduction portion 56A which converts the flow direction of some of the liquid flowing in the common liquid chamber 51 into the flow toward the pressure chamber 54 is provided on the secondary side of the pressure chamber 54. Therefore, since the liquid discharge head 21A can introduce the liquid into the pressure chamber 54 with a simple configuration, the liquid in the pressure chamber 54 can be circulated.

In addition, this embodiment is not limited to the above-described example. For example, in the above-described example, an example in which the pressure chamber 54 is a cylindrical space in the liquid discharge heads 21 and 21A is described, but there is no limitation thereto. For example, the pressure chamber 54 may have a rectangular columnar shape or an elliptical columnar shape, or may have a shape in which a plurality of cylindrical spaces are continuous or a truncated cone shape. In the example described above, the drive element 57 is provided on the other main surface of the plate 61 and around the nozzles 55, but there is no limitation thereto. For example, the drive element 57 may be integrally provided on the wall portion of the pressure chamber 54.

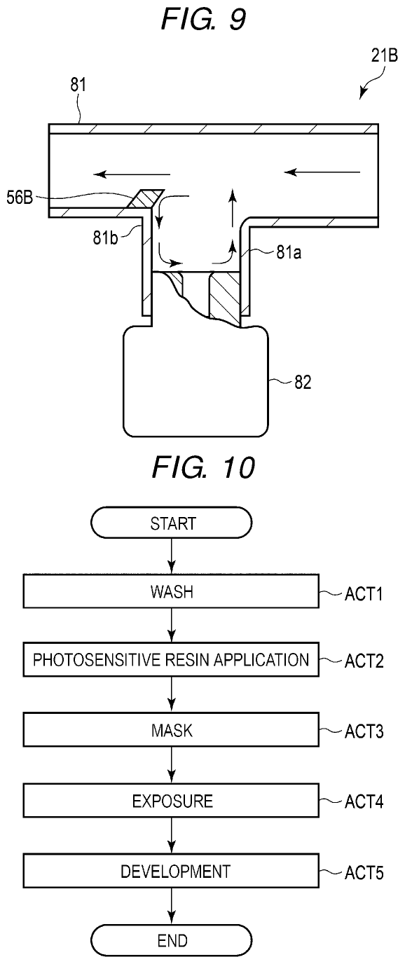

Further, in the above-described example, an example in which the liquid discharge heads 21 and 21A are used as the flow path members, the first chamber is used as the common liquid chamber 51, the second chamber is used as the pressure chamber 54, and the plate 61 and the flow path base 62 are used as the flow path portion is used and described, but there is no limitation thereto. That is, as long as a structure in which there is a closed or substantially closed chamber in a direction orthogonal to the flow direction of the liquid on the flow path through which the liquid flows in one direction is provided, the liquid introduction portion 56 can be applied. For example, as in a flow path member 21B in a third embodiment shown in FIG. 9, a liquid introduction portion 56B can be applied to the flow path member 21B in which a T-shaped tube used for a sprinkler or the like is used as a flow path portion 81, and a sprinkler head 82 is provided in a port 81a orthogonal to the flow path portion 81. In addition, the shape of the secondary side of the liquid introduction portion 56B may be a shape to be inclined in order to prevent retention of water.

The flow path member 21B having such a configuration is, for example, provided with the liquid introduction portion 56B having an inclined surface inclined toward the port 81a on the secondary side of a branch portion 81b branched to the port (chamber) 81a where the sprinkler head 82 of the flow path portion 81 is provided. With such a configuration, in the flow path member 21B, due to some of water, which is a liquid flowing in one direction in the flow path portion 81, flowing toward the port 81a in the liquid introduction portion 56B, even when the port 81a is closed by providing the sprinkler head 82, water is introduced to the port 81a. Thus, water does not stay in the port 81a. Therefore, the effect of preventing the concentration of chlorine contained in the water in the port 81a from being reduced and preventing precipitates from being deposited and the effect of preventing of malfunction of the sprinkler head 82, preventing use of unsanitary water as drinking water, and preventing the discharge of unsanitary water from the sprinkler head 82 can be exhibited. As described above, in the case of the flow path member in which the chamber exists in the direction orthogonal to the flow direction of the liquid on the flow path through which the liquid flows in one direction, the liquid introduction portion can be used appropriately.

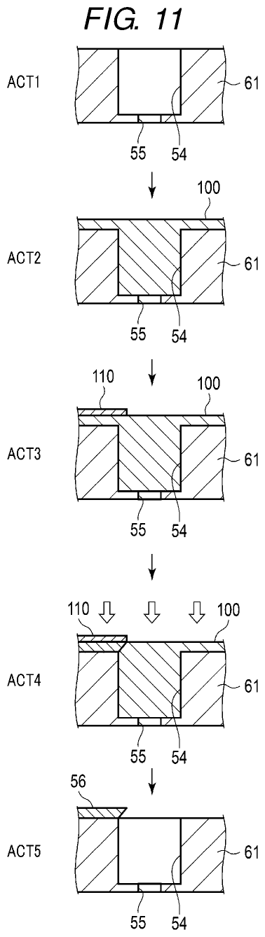

Further, in the above-described example, the configurations of the liquid discharge heads 21 and 21A are described, but, for example, a method of manufacturing the liquid discharge heads 21 and 21A can be set appropriately. Next, a method of manufacturing a liquid discharge head 21 used in the liquid discharge apparatus 1 according to a fourth embodiment will be described with reference to FIGS. 10 and 11. FIG. 10 is a flowchart showing a method of manufacturing the liquid introduction portion 56 as an example of the method of manufacturing the liquid discharge head 21 according to the fourth embodiment. FIG. 11 is an explanatory view showing the method of manufacturing the liquid introduction portion 56.

Since the configuration of the liquid discharge head 21 according to the fourth embodiment is the same as the configuration of the liquid discharge head 21 according to the first embodiment described above except for the manufacturing method and the material of the liquid introduction portion 56, the same components as those of the liquid discharge head 21 according to the first embodiment described above are denoted by the same reference numerals, and the detailed description thereof will be omitted.

As the example of the method of manufacturing the liquid discharge head 21, an example in which the plurality of liquid introduction portions 56 are formed on the plate 61 will be described below with reference to FIGS. 10 and 11.

The liquid introduction portion 56 according to the embodiment is formed of, for example, a photosensitive resin material. The liquid introduction portion 56 is formed by photolithography.

As shown in FIGS. 10 and 11, first, the plate 61 is washed (ACT 1). Next, a photosensitive resin is applied to the plate 61 on which the plurality of pressure chambers 54 and the plurality of nozzles 55 are formed (ACT 2). Specifically, a photosensitive resin material 100 is applied to the surface of the plate 61 on the common liquid chamber 51 side and the plurality of pressure chambers 54. The photosensitive resin material 100 is, for example, a positive photosensitive resin material. The surface of the plate 61 on the common liquid chamber 51 side is, for example, the surface of the first plate 61a.

Next, a mask 110 is provided on the photosensitive resin material 100 applied to the plate 61 (ACT 3). The mask 110 is formed in the shape of the main surface of the liquid introduction portion 56 and is provided at least in a region where the liquid introduction portion 56 of the photosensitive resin material 100 is to be formed.

Next, the photosensitive resin material 100 applied onto the plate 61 is exposed from the mask 110 side (ACT 4). As a specific example, light is emitted from a light source provided at a position separated from the plate 61 in the direction orthogonal to the main surface direction of the plate 61, and the pattern of the mask 110 is transferred. Here, for example, the light is ultraviolet light.

Next, the mask 110 is removed, and the photosensitive resin material 100 is developed (ACT 5). As a specific example, for example, the plate 61 containing the photosensitive resin material is immersed in a developer, or a developer is sprayed. Thus, the exposed photosensitive resin material 100 is dissolved in the developer, and the exposed photosensitive resin material 100 is removed from the plate 61. Thus, the photosensitive resin material 100 in the region where the mask 110 is formed and the liquid introduction portion 56 is to be formed remains on the plate 61. That is, the photosensitive resin material 100 remaining on the plate 61 after development constitutes the liquid introduction portion 56. In addition, when some of the light emitted from the light source at the time of exposure passes through a region not covered by the mask 110, the incident direction is inclined relative to the main surface of the plate 61 or the normal to the main surface of the photosensitive resin material 100. For this reason, as shown in FIG. 11, in the liquid introduction portion 56, the end face on the pressure chamber 54 side is inclined with respect to the flow direction of the liquid flowing in the common liquid chamber 51, and faces the pressure chamber 54. The liquid discharge head 21 is manufactured by integrally assembling the plate 61 in which the liquid introduction portion 56 is formed as described above and the flow path base 62.

The liquid introduction portion 56 of the liquid discharge head 21 configured as described above is molded by photolithography. In addition, since the end face on the pressure chamber 54 side of the liquid introduction portion 56 is inclined in the liquid introduction portion 56 by providing the mask 110 on the photosensitive resin material 100 and performing an exposure process, the liquid introduction portion 56 can be easily formed.

Moreover, according to the liquid discharge head 21 manufactured as described above, similar to the liquid discharge head 21 according to the first embodiment described above, the liquid in the chambers 54, 81a can be circulated with a simple configuration.

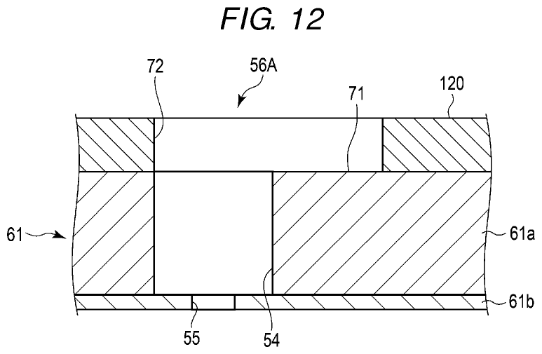

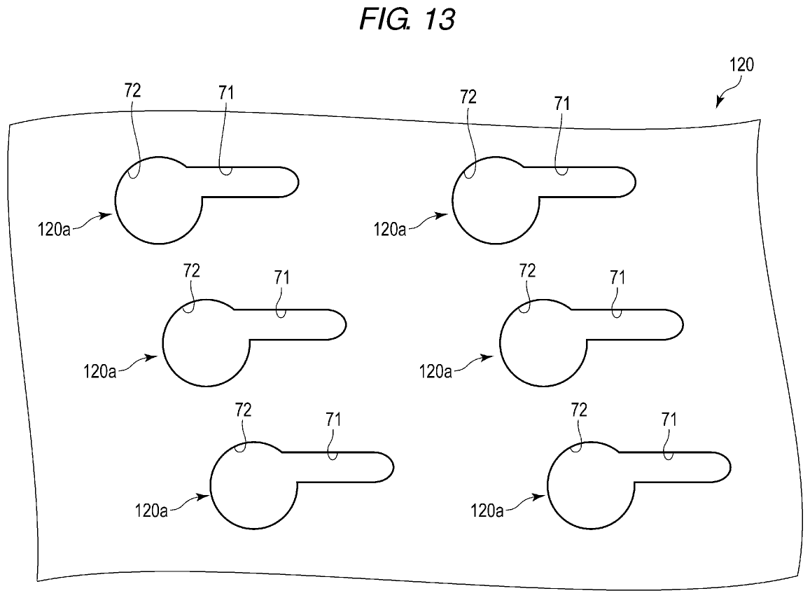

Next, a method of manufacturing the liquid discharge head 21A used in the liquid discharge apparatus 1 according to a fifth embodiment will be described with reference to FIGS. 12 and 13. FIG. 12 is a cross-sectional view schematically showing a configuration and the method of manufacturing the liquid discharge head 21A according to the fifth embodiment, and FIG. 13 is a plan view showing a configuration of a member 120 for forming the liquid introduction portion 56A used in the liquid discharge head 21A.

Since the configuration of the liquid discharge head 21A according to the fifth embodiment is the same as the configuration of the liquid discharge head 21A according to the second embodiment described above except for a configuration further including a third plate 120 as a member constituting the liquid introduction portion 56A, the same components as those of the liquid discharge head 21A according to the second embodiment described above are denoted by the same reference numerals, and the detailed description thereof will be omitted.

The plate 61 of the liquid discharge head 21A further includes the third plate 120 on the surface of the first plate 61a of the plate 61. That is, the plate 61 is formed by integrally bonding the first plate 61a, the second plate 61b, and the third plate 120.

The third plate 120 is a member fixed to the surface of the first plate 61a by an adhesive or the like. The third plate 120 has, for example, a plurality of openings 120a that constitute the first liquid introduction portion 71 and the second liquid introduction portion 72 including a part of the pressure chamber 54.

Next, an example of the method of manufacturing the liquid discharge head 21A will be described. First, the third plate 120 is molded. As a specific example, the plate-like member 120 is processed by punching, etching, electroforming, and the like. The plurality of openings 120a for forming the liquid introduction portion 56A in the plate 61 are formed in the third plate 120. Next, the third plate 120 in which the plurality of openings 120a are formed is attached and fixed to the surface of the first plate 61a by an adhesive or the like. The second plate 61b is also fixed to the first plate 61a. By integrally assembling the first plate 61a, the second plate 61b, and the third plate 120 through these processes, the plate 61 having the liquid introduction portion 56A in the pressure chamber 54 is formed. Next, by integrally assembling the plate 61 and the flow path base 62, the liquid discharge head 21A is manufactured.

In the liquid discharge head 21A configured as described above, for example, the liquid introduction portion 56A is formed by the plurality of plates 61a, 61b, and 120 for the plate 61. Then, the first liquid introduction portion 71 and the second liquid introduction portion 72 are provided in advance on the third plate 120 constituting the common liquid chamber 51 side of the plate 61, and the plate 120 is assembled integrally with the other plates 61a and 61b to constitute the plate 61.

Thus, the first liquid introduction portion 71 is formed by the surface of the first plate 61a and the openings 120a of the third plate 120. In addition, the second liquid introduction portion 72 is formed by the openings 120a of the third plate 120. Further, the plate 61 including the liquid introduction portion 56A is manufactured with a simple structure in which the openings 120a constituting the first liquid introduction portion 71 and the second liquid introduction portion 72 are processed to the third plate 120, and the plurality of plates 61a, 61b, and 120 are integrally assembled. Further, the process of forming the liquid introduction portion 56A into the third plate 120 may be a relatively easy processing method such as punching, etching, and electroforming, and the manufacture of the liquid discharge head 21A becomes easy.

Moreover, according to the liquid discharge head 21A manufactured in this manner, the liquid in the chambers 54 and 81a can be circulated with a simple configuration, as in the liquid discharge head 21A according to the second embodiment described above.

As in the liquid introduction portion 56A according to the second embodiment described above, when the depth of the primary side of the first liquid introduction portion 71 becomes gradually deeper from the primary side to the secondary side, and the intermediate portion of the primary side is configured to have a predetermined depth to the secondary side, the liquid introduction portion can be easily formed by forming the openings 120a of the third plate 120 by etching and adjusting the amount of etching.

According to the liquid discharge heads 21 and 21A or the flow path member 21B according to at least one embodiment described above, it is possible to circulate the liquid in the chambers 54 and 81a with a simple configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid discharge head, comprising:
a plate including a pressure chamber open to one main surface, a liquid introduction portion which directs a flow direction of at least a portion of a liquid toward the pressure chamber on a secondary side of the flow direction of the liquid at an opening of the pressure chamber, and a nozzle which is connected to the pressure chamber, the nozzle opens to another main surface and discharges the liquid; and
a flow path base provided on one main surface side of the plate and forms a liquid chamber in which the liquid flows with the plate along a surface direction of the one main surface.

2. The liquid discharge head according to claim 1, wherein
the liquid introduction portion is provided on the one main surface.

3. The liquid discharge head according to claim 1, wherein
the liquid introduction portion is provided on the secondary side in the flow direction of the liquid at the opening of the pressure chamber, the liquid introduction portion faces the pressure chamber and has an inclined surface inclined with respect to the surface direction of the one main surface.

4. The liquid discharge head according to claim 1, wherein
the liquid introduction portion is a groove provided on the one main surface and on a primary side in the flow direction of the liquid at the opening of the pressure chamber, the liquid introduction portion has an end connected to the pressure chamber and is formed along the flow direction of the liquid flowing in the liquid chamber.

5. The liquid discharge head according to claim 1, wherein
a width of the liquid introduction portion in a direction orthogonal to the flow direction of the liquid flowing in the liquid chamber is smaller than a width of the pressure chamber in the direction orthogonal to the flow direction of the liquid flowing in the liquid chamber.

6. The liquid discharge head according to claim 1, wherein
the pressure chamber has a cylindrical shape, a rectangular columnar shape or an elliptical columnar shape.

7. The liquid discharge head according to claim 1, wherein
the liquid introduction portion comprises a protrusion having an inclined surface.

8. A flow path member, comprising:
a flow path portion including a first chamber in which a liquid flows in one direction;
a second chamber which is connected to the flow path portion and is opened to an inner surface of the flow path portion; and
a liquid introduction portion which directs a flow direction of at least a portion of the liquid flowing in the first chamber on a secondary side of an opening of the second chamber toward the second chamber.

9. The flow path member according to claim 8, wherein
the liquid introduction portion is formed of a photosensitive resin.

10. The flow path member according to claim 8, wherein
the liquid introduction portion is provided on the one main surface.

11. The flow path member according to claim 8, wherein
the liquid introduction portion is provided on the secondary side in the flow direction of the liquid at the opening of a pressure chamber, the liquid introduction portion faces the pressure chamber and has an inclined surface inclined with respect to the surface direction of the one main surface.

12. The flow path member according to claim 8, wherein
the liquid introduction portion is a groove provided on the one main surface and on a primary side in the flow direction of the liquid at the opening of a pressure chamber, the liquid introduction portion has an end connected to the pressure chamber and is formed along the flow direction of the liquid flowing in the second liquid chamber.

13. The flow path member according to claim 8, wherein
a width of the liquid introduction portion in a direction orthogonal to the flow direction of the liquid flowing in the liquid chamber is smaller than a width of a pressure chamber in the direction orthogonal to the flow direction of the liquid flowing in the second liquid chamber.

14. The flow path member according to claim 8, wherein
the liquid introduction portion comprises a protrusion having an inclined surface.

15. An inkjet printer, comprising:
a paper cassette;
a paper conveying mechanism; and
a liquid discharge head, comprising:
a plate including a pressure chamber open to one main surface, a liquid introduction portion which directs a flow direction of at least a portion of a liquid toward the pressure chamber on a secondary side of the flow direction of the liquid at an opening of the pressure chamber, and a nozzle which is connected to the pressure chamber, the nozzle opens to another main surface and discharges the liquid; and
a flow path base provided on one main surface side of the plate and forms a liquid chamber in which the liquid flows with the plate along a surface direction of the one main surface.

16. The inkjet printer according to claim 15, wherein
the liquid introduction portion is provided on the one main surface.

17. The inkjet printer according to claim 15, wherein
the liquid introduction portion is provided on the secondary side in the flow direction of the liquid at the opening of the pressure chamber, the liquid introduction portion faces the pressure chamber and has an inclined surface inclined with respect to the surface direction of the one main surface.

18. The inkjet printer according to claim 15, wherein
the liquid introduction portion is a groove provided on the one main surface and on a primary side in the flow direction of the liquid at the opening of the pressure chamber, the liquid introduction portion has an end connected to the pressure chamber and is formed along the flow direction of the liquid flowing in the liquid chamber.

19. The inkjet printer according to claim 15, wherein
a width of the liquid introduction portion in a direction orthogonal to the flow direction of the liquid flowing in the liquid chamber is smaller than a width of the pressure chamber in the direction orthogonal to the flow direction of the liquid flowing in the liquid chamber.

20. The inkjet printer according to claim 15, wherein
the pressure chamber has a cylindrical shape, a rectangular columnar shape or an elliptical columnar shape.
